(19) United States
(12) Patent Application Publication
(10) Pub. No.: US 2025/0279887 A1
(43) Pub. Date: Sep. 4, 2025

(54) PROOF OF MEDIA METADATA INTEGRITY ON HASHGRAPH

(71) Applicants: Jerald Nine, Waco, TX (US); Jonathan Taft, Grandview, MO (US)

(72) Inventors: Jerald Nine, Waco, TX (US); Jonathan Taft, Grandview, MO (US)

(21) Appl. No.: 19/049,555

(22) Filed: Feb. 10, 2025

Related U.S. Application Data
(60) Provisional application No. 63/559,387, filed on Feb. 29, 2024.

(51) Int. Cl. H04L 9/32; H04L 9/00; H04L 9/08; H04L 9/14

(52) U.S. Cl. CPC H04L 9/32; H04L 9/0861; H04L 9/0894; H04L 9/14; H04L 9/50

(57) ABSTRACT

This invention presents a dual-layer verification system for authenticating digital media using HashGraph distributed ledger technology. By separately hashing and recording metadata on-chain while keeping media hashes off-chain, the system ensures authenticity while allowing controlled disclosure of the media hash. It supports optional metadata embedding within media files, re-hashing for integrity verification, and browser-based trust links for real-time validation. Rather than preventing deepfakes or deceptive content, this technology establishes a trusted repository and verification framework, providing a reliable news feed of authenticated media. This system enhances media integrity for applications in social media, journalism, and forensic investigations.

### CROSS-REFERENCE TO RELATED APPLICATION

This application claims the benefit of priority of U.S. provisional application No. 63/559,387, filed Feb. 29, 2024, the contents of which are herein incorporated by reference.

### BACKGROUND OF THE INVENTION

In today's digital landscape, verifying the authenticity of digital media content has become increasingly difficult. The rise of deepfakes, AI-generated images, and sophisticated manipulation techniques has made it challenging to distinguish between genuine and altered media. Existing distributed ledger-based verification solutions suffer from two major shortcomings:
1. Privacy Risks—Existing systems directly expose media file hashes on public distributed ledgers, whether blockchain- or DAG-based. This can lead to government censorship, where authorities or ISPs block access to specific media by adding the associated hash to a restricted list, effectively rendering the content inaccessible.
2. Media-of-Media Abuse—Current verification models lack robust metadata validation, making them susceptible to media-of-media attacks—such as taking a photo of a photo or recording a video of a video. These attacks exploit timestamp and location metadata, allowing falsified content to appear legitimate. Traditional hash-based authentication, which relies primarily on limited EXIF data, is inadequate for detecting such manipulations.

### SUMMARY OF THE INVENTION

The present invention introduces a novel dual-trust-key architecture that fundamentally reimagines digital media verification by separating metadata authentication from media hash disclosure. This system effectively balances privacy, security, and verifiability through a flexible dual-trust-key framework:
Trust Key 1: A metadata file hash, which is minted on the Hedera HashGraph, a public distributed ledger, ensuring a tamper-proof record of the media's contextual data without exposing the media file hash itself.
Trust Key 2: The media file hash, which is embedded within Trust Key 1's metadata file. This key can be selectively disclosed—either kept private or made public—recorded within the HCS (Hedera Consensus Service) message, rather than stored directly on the ledger, allowing privacy control while maintaining cryptographic integrity.

This adaptive design provides unprecedented flexibility, allowing organizations to verify digital media authenticity while safeguarding sensitive data. Unlike conventional blockchain- or DAG based verification systems, which rigidly expose media hashes and lack privacy controls, this approach ensures trust without compromising confidentiality. By enabling selective disclosure and decoupling verification from immutable exposure, it mitigates correlation risks while preserving content integrity.

At a technical level, the system employs a novel trust-link mechanism to enable both real-time and retrospective verification. This mechanism allows for automated cryptographic validation of content authenticity while leveraging the dual-key architecture to enhance privacy. The system utilizes HashGraph's consensus algorithm, ensuring high throughput, rapid finality, and scalability for practical deployment.

By establishing a robust and privacy-preserving verification framework, this invention enables trusted content validation across multiple domains, including journalism, legal documentation, and social media platforms. Through its innovative dual-key design, it ensures strong privacy guarantees while maintaining verifiability, security, and adaptability.

### BRIEF DESCRIPTION OF THE DRAWINGS

FIG. 1 provides an overview of the entire system and method for authenticating media file metadata on the Hedera HashGraph, a public distributed ledger technology (DLT). This figure illustrates the end-to-end user workflow, from capturing an image or video to verifying its integrity on the ledger, ensuring data immutability and trust.

FIG. 2 details the first part of the authentication process, as outlined in FIG. 1. It covers app usage, image capture, and metadata recording, including time, location, speed, and device information. Additionally, it illustrates the optional embedding of metadata within the image file and the transmission of data to the server for processing.

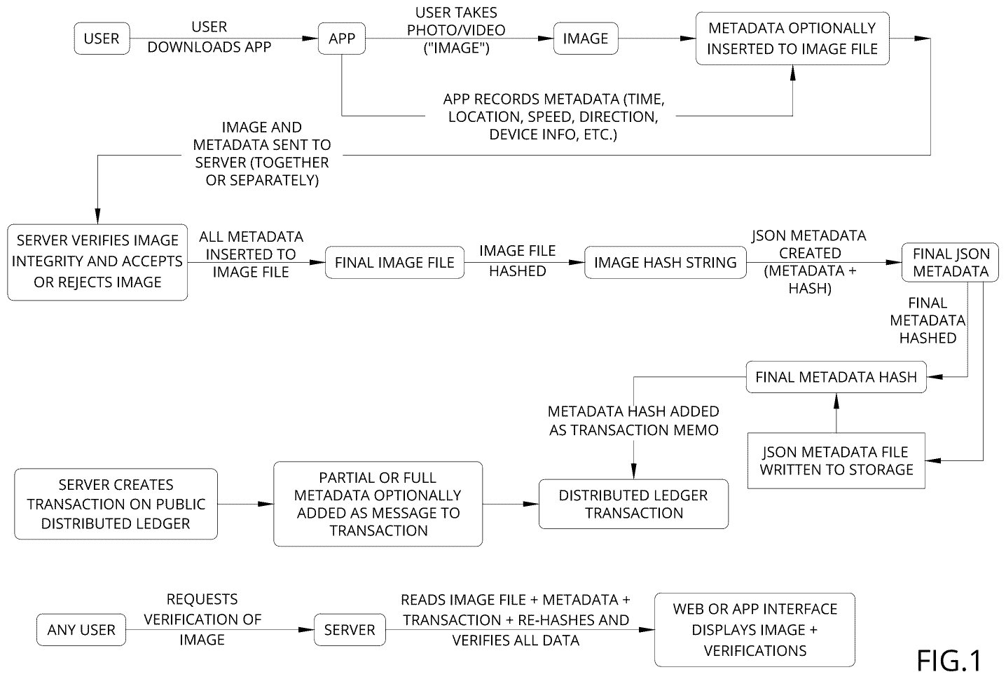

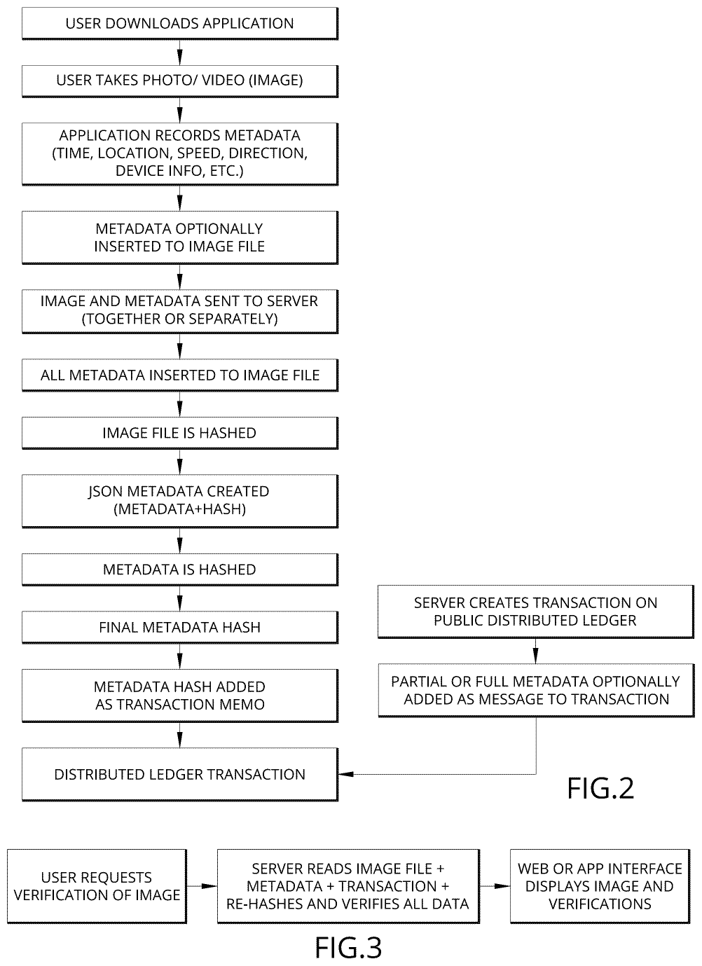

FIG. 3 presents the second part of the authentication process, completing the steps introduced in FIG. 1. It focuses on:
Hashing of the image file
Creation and hashing of metadata.
Integration with the HashGraph distributed ledger via transactions and memos
Final verification of the image and metadata through a web or app interface.

### DETAILED DESCRIPTION OF THE INVENTION

### Overview

The present invention introduces a dual-trust-key authentication system for digital media verification, leveraging HashGraph distributed ledger technology. This architecture enables a flexible verification process by cryptographically linking two trust components: Trust Key 1, which secures metadata integrity on the HashGraph, and Trust Key 2, which authenticates the media file while allowing its hash to remain private or, at the user's discretion, be publicly recorded in an HCS message (linked to the ledger but not stored directly on-chain). By decoupling media hash storage from the core ledger transaction, this system ensures robust verification, adaptable privacy controls, and enhanced security without compromising public verifiability.

The implementation specifically leverages Hedera HashGraph's consensus protocol to achieve high throughput and rapid transaction finality. Unlike traditional blockchain or other DAG-based approaches that permanently expose media hashes on-chain, this system's dual-trust-key architecture enables selective disclosure, allowing users to control hash visibility while preserving full verifiability.

### System Architecture and Operation

The system implements a dual-trust-key verification framework through the following technical processes:

### 1. Media Capture and Metadata Collection

The process begins when a user captures media (videos or photos) through a secure application (iOS, Android, Web, Windows, Mac, Linux). Upon capture, the app automatically collects and validates a comprehensive set of metadata, which may include but not limited to:
High-precision temporal data: Timestamp with UTC offset
Geospatial coordinates: Latitude, longitude, and altitude
Device motion vectors: Speed, direction, and acceleration
Hardware specifications: Device model, OS version, and security state
Sensor readings: Compass, gyroscope, and accelerometer

### 2. Dual-Layer Transmission Protocol

The system supports two distinct methods for transporting media with its associated metadata:

### a) Embedded Transmission:

Metadata is embedded within the media file on-device
Ensures an atomic relationship between content and metadata
Preserves original capture parameters for integrity

### b) Separate/Parallel Transmission:

Media and metadata are transmitted as separate encrypted streams
Maintains cryptographic linkage via secure identifiers
Enables selective metadata privacy controls
Optimized for low-bandwidth or weak cellular coverage

### 3. Dual-Trust-Key Generation and Ledger Storage

The system establishes its chain of trust through two distinct cryptographic keys:

### a) Trust Key 2 (Media Authentication):

Generates cryptographic hash of the complete media file with embedded metadata.
Creates unique digital fingerprint for the specific media instance
Maintains hash security through off-chain storage and selective disclosure

### b) Trust Key 1 (Metadata Verification):

Creates structured JSON metadata container including:
   Media file hash reference (Trust Key 2)
   Complete metadata payload
Generates metadata hash (Trust Key 1)
Stores Trust Key 1 on Hedera HashGraph via transaction memo

### c) Media and Metadata URL Handling & Access Control:

System stores cloud copies of the final media and metadata files.
These copies are linked to URLs recorded in the HCS message using an obfuscated identifier to ensure integrity and ease of verification.
For high-security scenarios, URLs are restricted and inaccessible to the public, ensuring controlled access.
For low-security scenarios, URLs remain openly accessible for ease of verification and transparency.

### d) Media Hash Privacy & Selective Disclosure:

The media file hash is publicly recorded in an HCS message by default, linking it to the ledger for verification while keeping it off-chain.
Users can opt to keep the media hash private, ensuring it remains undisclosed while still cryptographically verifiable.
This selective disclosure model decouples media hash storage from the core ledger transaction, providing flexibility without compromising integrity.
By allowing users to control hash visibility, the system balances public verifiability, privacy, and security, adapting to different trust requirements.

### 4. Dual-Layer Verification Protocol

Users can verify content through two methods:

### a) Manual Verification:

Direct comparison of JSON metadata hash against HashGraph transaction
Cryptographic validation of Trust Key 1 and Trust Key 2
Full metadata integrity verification

### b) Automated Trust Link Verification:

### 1. Retrieval Phase:

Fetches cloud-stored media file.
Retrieves cloud-stored JSON metadata file containing Trust Key 2
Accesses HashGraph transaction memo with Trust Key 1

### 2. Metadata Verification:

Re-hashes JSON metadata file
Validates against Trust Key 1 on HashGraph
Confirms metadata integrity

### 3. Media Authentication:

Re-hashes media file
Compares against Trust Key 2 from verified json metadata file
If matched, it validates the media is authentic as well as the time, date, location, and all other metadata.

### 5. Access Control and Transparency Layer

The system provides multiple verification interfaces:
Web-based verification portal for media/metadata validation
Mobile application for real-time authentication
API endpoints for programmatic verification

Users can:
Verify temporal and spatial authenticity of media
Detect post-capture modifications
Access immutable HashGraph transaction records.
Generate shareable trust links with configurable privacy controls

Creators can:
Set their media and JSON metadata files to public or private
Delete their media and JSON metadata files, preventing future access while leaving the immutable metadata hash recorded on HashGraph intact.

This implementation ensures robust verification while maintaining privacy through the dual-trust-key architecture and selective hash exposure.

### Advantages of the Invention

The present invention offers several key technical advantages over conventional media authentication methods:

### 1. Dual-Layer Hashing for Comprehensive Authentication

Unlike traditional verification techniques that rely solely on media file hashes, this system provides:
   Optional privacy control for the media file hash (Trust Key 2), preventing unnecessary public exposure.
   Establishes a reliable chain of trust through the metadata hash (Trust Key 1)
   Implements cryptographic separation while maintaining verifiability
   Selective disclosure of verification data

### 2. Immutable Ledger for Public and Legal Trust

By leveraging HashGraph technology:
   Achieves efficient processing of thousands of authenticated media files per second
   Creates permanent, tamper-proof records for evidentiary purposes
   Enables transparent verification through consensus-based validation
   Maintains immutable proof of authenticity for legal and journalistic requirements

### 3. Real-Time Verification to Combat Misinformation

The system provides:
   Immediate verification of captured photos and videos
   Reliable source of truth for digital media authenticity
   Effective countermeasures against deepfakes and AI-generated content
   Robust detection of manipulated or altered media

### 4. Scalability for Social Media, Journalism, and Legal Applications

The invention supports multiple domains, including:
   Journalism: Embedding trusted images in news reports
   Legal and Law Enforcement: Authenticating crime scene photos and video evidence
   Social Media Platforms: Ensuring trusted content is prioritized over manipulated media

### 5. User-Friendly and Accessible

Verification can be conducted by any user via:
   Web-based verification portal
   Mobile application interface
   Providing broad accessibility without requiring specialized knowledge
   Supporting intuitive trust link sharing and validation

### CONCLUSION

The present invention introduces a groundbreaking approach to digital media authentication, combining dual-trust-key cryptographic verification with the Hashgraph distributed ledger to establish an immutable chain of trust. By securing both media files and metadata, this system raises the standard for digital authenticity, ensuring verifiable proof for journalism, legal evidence, and the fight against misinformation on social media.

The system's unique combination of off-chain media hash storage and on-chain metadata verification enables both privacy and transparency, offering a scalable framework that meets the demands of high-volume applications while maintaining legal admissibility standards. Through its user-friendly interfaces and automated trust links, the invention empowers users to capture, verify, and share authenticated digital content with confidence, establishing a new standard for trusted media in an era of increasing digital manipulation.

What is claimed is:

1. A method for verifying the authenticity of digital media through cryptographic validation with 2 trust keys and the Hedera Hashgraph, the method comprising:
Capturing digital media (video or image) and contextual metadata of media (video or image) via a secure application (iOS, Android, Web, Windows, Mac, Linux);
Generating a cryptographic identifier for the media file (Trust Key 2);
Generating a separate json metadata file that includes the contextual metadata of the media as well as the media file hash (Trust Key 2);
Storing the json metadata cryptographic identifier (Trust Key 1) on the Hedera Hashgraph distributed ledger (a DAG based DLT);
Verifying media authenticity by matching Trust Key 1 from the ledger with the JSON metadata file hash and Trust Key 2 from the authenticated JSON metadata file with the actual media file hash.

2. The method of claim 1, wherein the only strictly on-chain metadata is the cryptographic hash of the metadata file.

3. The method of claim 1, wherein the Hashgraph distributed ledger transaction has an attached HCS message that include at least one of the following:
Media ID
Media file hash (selectively allowed/disallowed by the user)
Media info URL (configurable as public or private)
Media timestamp
Media file URL (configurable as public or private)
Last blockchain block reference
Last block timestamp
Metadata file hash
Metadata file URL (configurable as public or private)
Software version.

4. The method of claim 1, wherein off-chain metadata is stored in a structured JSON metadata file and includes at least one of the following:
Sensor Data:
Accelerometer readings
Raw accelerometer readings
Compass accuracy
Compass direction
Gyroscope readings
Heading direction
Heading accuracy
Magnetometer readings
Geospatial Data:
Altitude at the time of capture
Altitude accuracy
Geographic coordinates (latitude, longitude)
Location accuracy level
Speed at the time of capture
Speed accuracy level
Device Status & Security:
Battery level at the time of capture
Jailbroken status of the capturing device
Blockchain References:
Last recorded blockchain block reference
Last blockchain timestamp
File Identifiers & Links:
Media ID
Media file hash
Media info URL (configurable as public or private)
Media timestamp
Media file URL (configurable as public or private)
Metadata file URL (configurable as public or private)
Device Information:
Model of the capturing device
Platform (iOS, Android, etc)
Software Information:
Software name used for capturing
Software version number
User Identifier:
A unique identifier for the user capturing the media.

5. The method of claim 1, further comprising an automated trust link verification system that allows cloud-stored copies of media files to be verified against HashGraph trust keys, the method comprising:
Media info URL is a Trust link that displays copies of the media file and json metadata to compare against the trust key on the Hashgraph
Displaying a verification status in real-time.

6. The method of claim 5, wherein the verification system:
Allows users to scan a trust link QR code to verify a media file's authenticity;
Supports public or private media verification;
Enables automated periodic re-verification to detect tampering.

7. The method of claim 1, wherein the metadata is embedded directly into the media file before transmission.

8. The method of claim 1, wherein the media file and metadata are transmitted separately to the cloud storage system for further processing.

9. The method of claim 1, wherein the device is checked to determine whether it is jailbroken or rooted.

10. The method of claim 1, wherein the system verifies against “media of media” fraud by detecting:
Moiré patterns in images or video using ML models;
Light depth inconsistencies using LiDAR sensors;
Metadata discrepancies in environment-based location verification.

11. The method of claim 1, wherein augmented reality (AR) is used to capture a panoramic scene to mitigate against deception and abuse.

12. The method of claim 1, wherein the verification process supports offline media capture and delayed blockchain minting.

13. The method of claim 1, wherein a digital rewards system incentivizes verified media submissions using tokenized incentives.
